(19) United States
(12) Patent Application Publication
(10) Pub. No.: US 2007/0233821 A1
(43) Pub. Date: Oct. 4, 2007

(54) Managing system availability

(76) Inventors: Douglas Sullivan, Hopkinton, MA (US); Keith A. Morrissette, Whitinsville, MA (US); Steven D. Sardella, Hudson, MA (US)

Correspondence Address: RICHARD M. SHARKANSKY, PO BOX 557, MASHPEE, MA, 02649, US

(21) Appl. No.: 11/394,699

(22) Filed: Mar. 31, 2006

(51) Int. Cl. G06F 15/177; G06F 15/16

(52) U.S. Cl. 709/220; 709/227

(57) ABSTRACT

System availability is managed. It is determined that a data communications link has been established and that the data communications link is less than fully functional. Communication is performed across the data communications link to a device to configure the device for the data communications link. The device is caused to re-establish the data communication link based on the results of the configuring.

### FIELD OF THE INVENTION

The present invention relates to managing system availability.

### BACKGROUND OF THE INVENTION

Today's networked computing environments are used in businesses for generating and storing large amounts of critical data. The systems used for moving, storing, and manipulating this critical data are expected to have high performance, high capacity, and high reliability, while being reasonably priced.

As is known in the art, large computer systems and data servers sometimes require large capacity data storage systems. One type of data storage system is a magnetic disk storage system. Here a bank of disk drives and the computer systems and data servers are coupled together through an interface. The interface includes storage processors that operate in such a way that they are transparent to the computer. That is, data is stored in, and retrieved from, the bank of disk drives in such a way that the computer system or data server merely thinks it is operating with one memory. One type of data storage system is a RAID data storage system. A RAID data storage system includes two or more disk drives in combination for fault tolerance and performance.

One conventional data storage system includes two storage processors for high availability. Each storage processor includes a respective send port and receive port for each disk drive. Accordingly, if one storage processor fails, the other storage processor has access to each disk drive and can attempt to continue operation.

Modern computer systems typically use a computer architecture that may be viewed as having three distinct subsystems which when combined, form what most think of when they hear the term computer. These subsystems are: 1) a processing complex; 2) an interface between the processing complex and I/O controllers or devices; and 3) the I/O (i.e., input/output) controllers or devices themselves. A processing complex may be as simple as a single microprocessor, such as a Pentium microprocessor, coupled to memory. Or, it might be as complex as two or more processors which share memory.

A blade server is essentially a processing complex, an interface, and I/O together on a relatively small printed circuit board that has a backplane connector. The blade is made to be inserted with other blades into a chassis that has a form factor similar to a rack server today. Many blades can be located in the same rack space previously required by just one or two rack servers. Blade servers typically provide all of the features of a pedestal or rack server, including a processing complex, an interface to I/O, and I/O. Further, the blade servers typically integrate all necessary I/O because they do not have an external bus which would allow them to add other I/O on to them. So, each blade typically includes such I/O as Ethernet (10/100, and/or 1 gig), and data storage control (SCSI, Fiber Channel, etc.).

The interface between the processing complex and I/O is commonly known as the Northbridge or memory control hub (MCH) chipset. On the “north” side of the chipset (i.e., between the processing complex and the chipset) is a bus referred to as the HOST bus. The HOST bus is usually a proprietary bus designed to interface to memory, to one or more microprocessors within the processing complex, and to the chipset. On the “south” side of the chipset are a number of buses which connect the chipset to I/O devices. Examples of such buses include: ISA, EISA, PCI, PCI-X, and Peripheral Component Interconnect (PCI) Express.

PCI Express is an I/O interconnect architecture that is intended to support a wide variety of computing and communications platforms and is described in the PCI Express Base Specification, Rev. 1.0a, Apr. 15, 2003 (hereinafter, “PCI Express Base Specification” or “PCI Express standard”). The PCI Express architecture describes a fabric topology in which the fabric is composed of point-to-point links that interconnect a set of devices. For example, a single fabric instance (referred to as a “hierarchy”) can include a Root Complex (RC), multiple endpoints (or I/O devices) and a switch. The switch supports communications between the RC and endpoints, as well as peer-to-peer communications between endpoints.

The PCI Express architecture is specified in layers, including software layers, a transaction layer, a data link layer and a physical layer. The software layers generate read and write requests that are transported by the transaction layer to the data link layer using a packet-based protocol. The data link layer adds sequence numbers and CRC to the transaction layer packets. The physical layer transports data link packets between the data link layers of two PCI Express agents. The physical layer supports “x N” link widths, that is, links with N lanes (where N can be 1, 2, 4, 8, 12, 16 or 32). The physical layer byte stream is divided so that bytes are transmitted in parallel across the lanes.

For each end point, each PCI Express lane has a signal transmission pair and a signal receiving pair. For the current specification, PCI express has a differential signal transmission speed as high as 2.5 Gbps. PCI express data transceiving requires four physical signals, and a plurality of control signals. Compared to PCI, the PCI Express can achieve a higher transmission rate with less physical pins. The various PCI Express hardware specifications, including single lane, 4 lanes, 8 lanes, 16 lanes and 32 lanes, are defined to meet the different bandwidth requirement of various peripheral devices. For example, a graphic card which needs a large bandwidth may use a 32-lane PCI Express interface.

During link training, each PCI Express link is set up following a negotiation of link widths, frequency of operation and other parameters by the ports at each end of the link.

Fibre Channel is a high performance, serial interconnect standard designed for bi-directional, point-to-point communications between servers, storage systems, workstations, switches, and hubs. It offers a variety of benefits over other link-level protocols, including efficiency and high performance, scalability, simplicity, ease of use and installation, and support for popular high level protocols.

The Fibre Channel protocol (“FCP”) uses a single Open-Systems-Interface-like (OSI-like) stack architecture. Devices that are operable with the Fibre Channel protocol typically include a controller (an “FC controller”) that embodies the functionality of some of the middle-layers of the FCP stack. Furthermore, FC controllers may involve a “controller chip”. As part of the middle-layer FCP functionality, these FC controllers monitor the state of information transmissions over the FC communication links and are designed to take appropriate recovery measures should an unresponsive communication link be encountered.

A typical type of computer system test calls for the processor to execute firmware/software that operates at a lower level than an operating system based program, prior to booting the operating system. These include basic I/O system (BIOS) and power on self test (POST) programs. These types of tests provide relatively low-level control of component functionality and interconnect buses.

There is a low level technique known as boundary scan testing (or the joint Test Access Group, JTAG, protocol) which calls for on-chip circuitry used to control individual bits transmitted between components. JTAG has been standardized by the IEEE (Institute of Electrical and Electronic Engineers). For example, components on boards often have pins dedicated to JTAG, which allows testing the continuity of device pins and board signals.

A built-in self test (BIST) unit, which resides in an IC component of the system and is separate in function from the core of the IC component, may be provided with a control interface (e.g., JTAG). This permits configuration and programming (e.g., via a tester external to the computer system board and platform; on-board system firmware or BIOS programming) of an interconnect built-in self test (IBIST) test pattern.

Programmable devices are a class of general-purpose integrated circuits (ICs) that can be configured for a wide variety of applications. Such programmable devices have two basic versions, mask programmable devices, which are programmed only by a manufacturer, and field programmable devices, which are programmable by the end user. In addition, programmable devices can be further categorized as programmable memory devices or programmable logic devices. Programmable memory devices include programmable read only memory (PROM), erasable programmable read only memory (EPROM) and electrically erasable programmable read only memory (EEPROM). Programmable logic devices (PLDs) include programmable logic array (PLA) devices, programmable array logic (PAL) devices, erasable programmable logic devices (EPLD), complex programmable logic devices (CPLD), and programmable gate arrays (PGAs) or field programmable gate arrays (FPGAs).

Electronic design automation (EDA) systems allow designers of IC devices, and also designers who want to implement a design on a PLD, to use high level language (HDL) descriptions to represent their IC or PLD designs (e.g., hardware designs) at an abstract or high level. In addition to HDL, the design descriptors can also include any method of representing a hardware design, such as schematic, combination and others. These schematic or HDL descriptions are then synthesized by computer implemented processes that generate technology dependent descriptions of the IC or PLD design called “netlists.” The PLD chip can be a CPLD or an FPGA. These programmable logic devices contain generic functional modules that can be electrically coupled together and programmed to perform certain functions and generate specific signals such that an IC or PLD design can be realized in hardware.

### SUMMARY OF THE INVENTION

System availability is managed. It is determined that a data communications link has been established and that the data communications link is less than fully functional. Communication is performed across the data communications link to a device to configure the device for the data communications link. The device is caused to re-establish the data communication link based on the results of the configuring.

One or more embodiments of the invention may provide one or more of the following advantages.

Practical limitations of existing implementations of standards-based technology can be overcome, thus improving time to market. Standard PCI Express technology typically used at an initial stage can be applied at a later stage to provide a failure tolerant PCI Express system.

Other advantages and features will become apparent from the following description, including the drawings, and from the claims.

### BRIEF DESCRIPTION OF THE DRAWINGS

In order to facilitate a fuller understanding of the present invention, reference is now made to the appended drawings. These drawings should not be construed as limiting the present invention, but are intended to be exemplary only.

FIG. 1 is an isometric view of a storage system in which the invention may be implemented.

FIG. 2 is a schematic representation of a first configuration of the system of FIG. 1 showing a blades, two expansion slots, and two I/O modules installed in the expansion slots.

FIG. 3 is a schematic representation of a second configuration of the system of FIG. 1 showing the blades, two expansion slots, and one shared cache memory card installed in both the expansion slots.

FIG. 4 is a schematic representation of a system that may be used in or with the system of FIG. 1.

FIG. 5-9 are flow diagrams of procedure for use with the system of FIG. 4.

### DETAILED DESCRIPTION

In at least one implementation described in more detail below, a robust boot implementation is provided in a data storage system that includes, among other actions, possibly power cycling a board up to a selected number of times (e.g., three times) in the event of failure to help improve system availability.

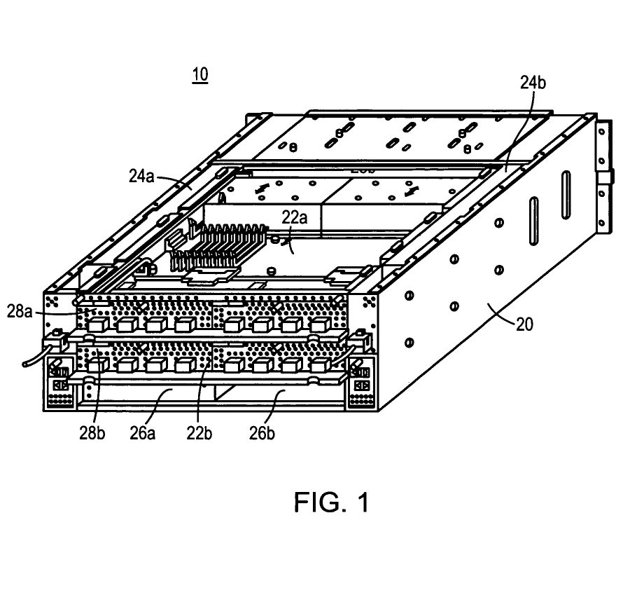

Referring to FIG. 1, there is shown a portion of a storage system 10 that is one of many types of systems in which the principles of the invention may be employed. The storage system 10 shown may operate stand-alone or may populate a rack including other similar systems. The storage system 10 may be one of several types of storage systems. For example, if the storage system 10 is part of a storage area network (SAN), it is coupled to disk drives via a storage channel connection such as Fibre Channel. If the storage system 10 is, rather, a network attached storage system (NAS), it is configured to serve file I/O over a network connection such as an Ethernet.

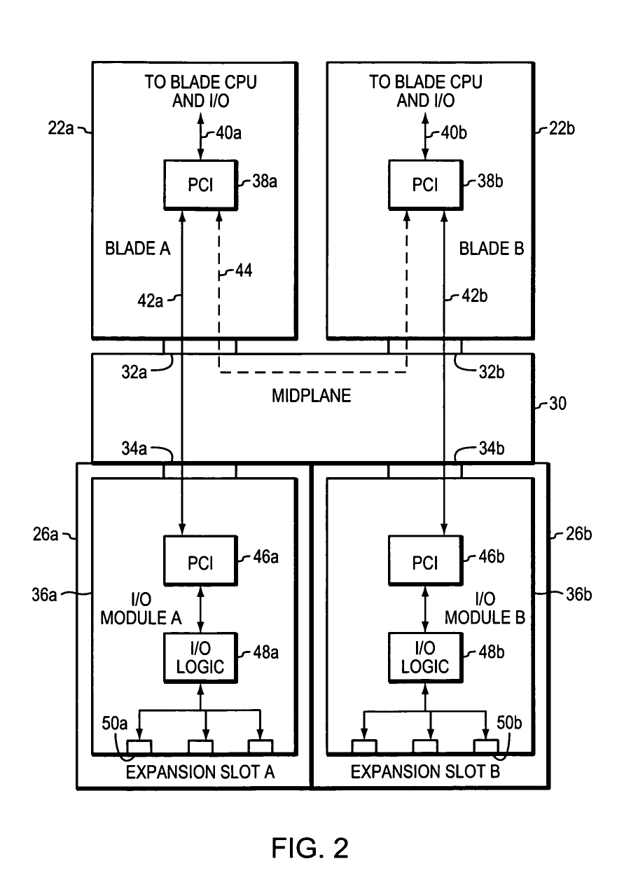

The storage system 10 includes within a chassis 20 a pair of blades 22a and 22b, dual power supplies 24a,b and dual expansion slots 26a,b. The blades 22a and 22b are positioned in slots 28a and 28b respectively. The blades 22a,b include CPUs, memory, controllers, I/O interfaces and other circuitry specific to the type of system implemented. The blades 22a and 22b are preferably redundant to provide fault tolerance and high availability. The dual expansion slots 26a,b are also shown positioned side by side and below the blades 22a and 22b respectively. The blades 22a,b and expansion slots 26a,b are coupled via a midplane 30 (FIG. 2). In accordance with the principles of the invention, the expansion slots 26a,b can be used in several ways depending on system requirements.

In FIG. 2, the interconnection between modules in the expansion slots 26a,b and the blades 22a,b is shown schematically in accordance with a first configuration. Each blade 22a,b is coupled to the midplane 30 via connectors 32a,b. The expansion slots 26a,b are also shown coupled to the midplane 30 via connectors 34a,b. The blades 22a,b can thus communicate with modules installed in the expansion slots 26a,b across the midplane 30. In this configuration, two I/O modules 36a and 36b are shown installed within the expansion slots 26a and 26b respectively and thus communicate with the blades 22a,b separately via the midplane 30.

In accordance with a preferred embodiment, the blades 22a,b and I/O modules 36a,b communicate via PCI Express buses—though it will be understood that PCI Express is only one example of many different types of busses that could be employed. (PCI Express is described in the PCI-SIG document “PCI Express Base Specification 1.0a” and accompanying documentation.) Each blade 22a,b includes a PCI Express switch 38a,b that drives a PCI Express bus 40a,b to and from blade CPU and I/O resources. The switches 38a,b (also known as “peer/annex bridges”) split each PCI Express bus 40a,b into two PCI Express buses. One PCI Express bus 42a,b is coupled to the corresponding expansion slot 26a,b. The other PCI Express bus 44 is coupled to the other blade and is not used in this configuration—thus it is shown dotted. The 1/Q modules 36a,b are PCI Express cards, including PCI Express controllers 46a,b coupled to the respective bus 42a,b. Each 1/O module 36a,b includes I/O logic 48a,b coupled to the PCI Express controller 46a,b for interfacing between the PCI Express bus 42a,b and various interfaces 50a,b such as one or more Fibre Channel ports, one or more Ethernet ports, etc. depending on design requirements. Furthermore, by employing a standard bus interface such as PCI Express, off-the-shelf PCI Express cards may be employed as needed to provide I/O functionality with fast time to market.

The configuration of FIG. 2 is particularly useful where the storage system 10 is used as a NAS. The NAS is I/O intensive; thus, the I/O cards provide the blades 22a,b with extra I/O capacity, for example in the form of gigabit Ethernet ports.

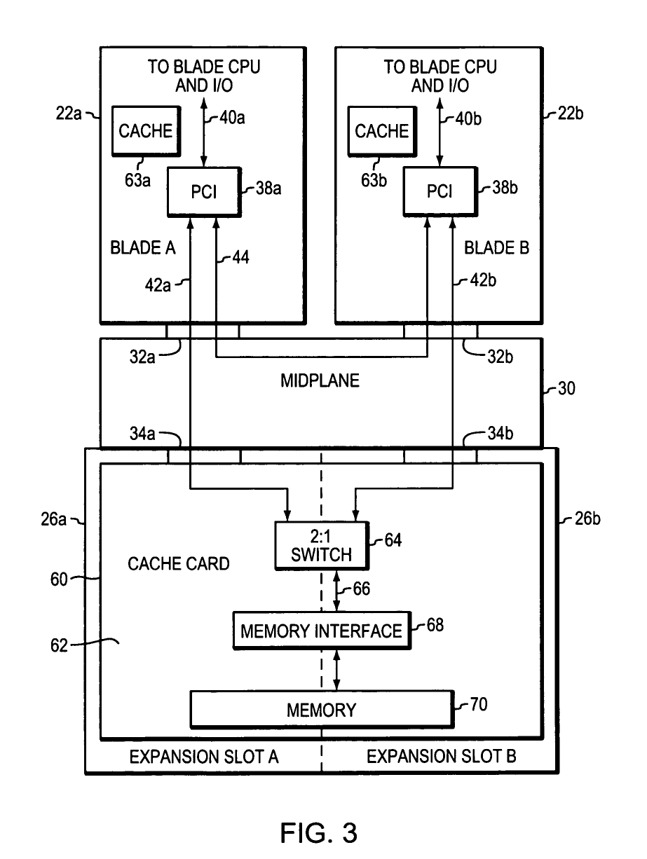

Referring to FIG. 3, there is shown an alternate arrangement for use of the expansion slots 26a,b. In this arrangement, a single shared resource 60 is inserted in both the expansion slots 26a,b and is shared by the blades 22a,b. The shared resource 60 may be for example a cache card 62. The cache card 62 is particularly useful for purposes of high availability in a SAN arrangement. In a SAN arrangement using redundant blades 22a,b as shown, each blade includes cache memory 63a,b for caching writes to the disks. During normal operation, each blade's cache is mirrored in the other. The blades 22a,b mirror the data between the caches 63a,b by transferring it over the PCI Express bus 44. If one of the blades, for example blade 22a, fails, the mirrored cache 63a becomes unavailable to the other blade 22b. In this case, the surviving blade 22b can access the cache card 62 via the PCI Express bus 42b for caching writes, at least until the failed blade 22a recovers or is replaced.

As seen in FIG. 3, the cache card 62 includes a two-to-one PCI Express switch 64 coupled to the PCI Express buses 42a,b. The switch 64 gates either of the two buses to a single PCI Express bus 66 coupled to a memory interface 68. The memory interface 68 is coupled to the cache memory 70. Either blade 22a or 22b can thus communicate with the cache memory 70.

Referring to both FIGS. 2 and 3, it is noted that the PCI Express bus 44 is not used in the NAS arrangement but is used in the SAN arrangement. Were the PCI Express switches 38a,b not provided, the PCI Express bus 40a,b would be coupled directly to the PCI Express bus 44 for SAN functionality and thus would not be usable in the NAS arrangement. Through addition of the switches 38a,b, the PCI Express bus 40a,b is useful in the NAS arrangement when the PCI Express bus 44 is not in use, and is useful in the SAN arrangement during a blade failure. Note that the PCI Express bus 44 and the PCI Express buses 42a,b are not used at the same time, so full bus bandwidth is always maintained.

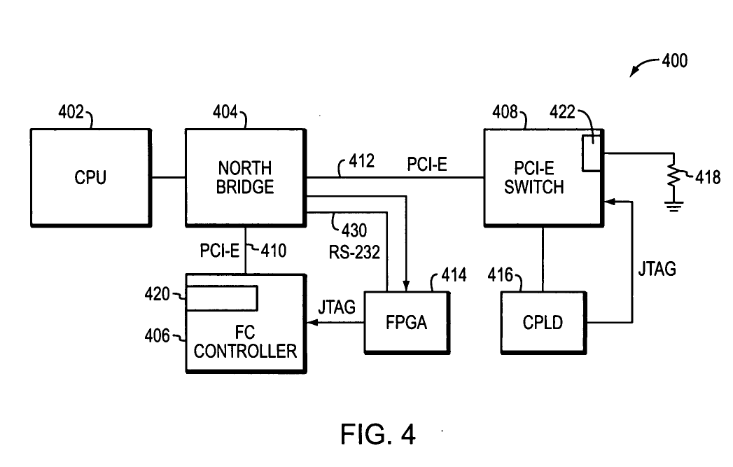

FIG. 4 illustrates a processing system 400 that may be used in or by system 10 above, and/or may be used in or by a different system. In a particular implementation, at least a portion of system 400 may reside on blade 22a or 22b. Northbridge 404 allows CPU 402 to communicate with Fibre Channel controller 406 and PCI Express switch 408 over respective PCI Express links 410, 412. Switch 408 may serve as or be included in switch 38a or 38b above, and link 412 may use bus 40a or 40b above. As described below, FPGA 414 is used with Northbridge 404 and controller 406, and CPLD 416 and resistor 418 are used with switch 408. In at least one embodiment, system 10 includes features described in the following co-pending U.S. patent applications which are assigned to the same assignee as the present application, and which are incorporated in their entirety herein by reference: serial no. Not Yet Assigned, docket no. EMC-06-035, filed concurrently herewith entitled “Managing System Components”; Ser. No. 10/330,806, docket no. EMC-02-110, filed Dec. 28, 2002 entitled “Method and Apparatus for Preserving Data in a High-Availability System”; Ser. No. 10/881,562, docket no. EMC-04-063, filed Jun. 30, 2004 entitled “Method for Caching Data”; Ser. No. 10/881,558, docket no. EMC-04-117, filed Jun. 30, 2004 entitled “System for Caching Data”; Ser. No. 11/017,308, docket no. EMC-04-265, filed Dec. 20, 2004 entitled “Multi-Function Expansion Slots for a Storage System”.

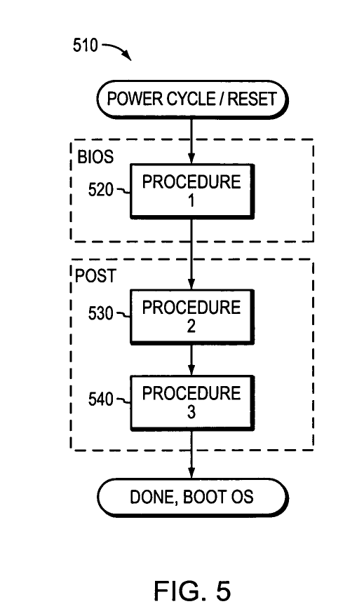

FIG. 5 illustrates that CPU 402 executes a power up/reset procedure 510 that includes a BIOS based procedure 520 and POST based procedures 530, 540. In at least one implementation, procedures 520, 530, 540 are executed from firmware. BIOS based procedure 520 is executed on every reboot or power cycle. The POST based procedures are attempted a specific number of times (e.g., three times) before POST is halted and error messages are displayed.

In general, the procedures provide an ability to detect a problem, e.g., a configuration problem, potentially take action useful toward a remedy, and initiate a power cycle to try to improve the state of the system and determine whether the problem persists.

In at least some implementations of a PCI Express link, multiple lanes in the link work in tandem, e.g., one lane up to eight lanes, with more throughput or bandwidth being possible with more lanes working simultaneously within the link. In such implementations, the link also supports a training procedure in which devices (e.g., Northbridge 404 and controller 406) on opposite sides of a group of lanes (e.g., for link 410) send out training sequences in an attempt to determine how many lanes are operational between the two devices, and if the devices thereby successfully negotiate a non-zero link width, they can start using the link for communication after that point. Depending on how many functioning lanes the devices find during training, the devices adapt, such that if they find only one good lane, they use that lane, and if they find two, four, or eight lanes, they use those. For example, if a conventional PCI Express I/O card is plugged into a conventional PCI Express motherboard, the training causes the card and the motherboard to settle on a link width that is the maximum width supported by both the card and the motherboard.

Without further limitations, the training procedure can aid fault handling in a system, because if a link initially trains to a link width of multiple lanes, and subsequently one of those lanes fails, the link can train again (retrain) to a link width of fewer lanes. Such a link can retain a working connection while the fault is being reported. However, in at least some practical applications or implementations of PCI Express, practical limitations exist that affect when the link will retrain and which lanes need to be working in order for retraining to be possible. Thus, the practical limitations need to be taken into account to allow for retraining so that the link can be adjusted on the fly, e.g., to respond to a fault such as a lane failure.

Procedure 520 addresses a circumstance with controller 406, which has a register 420 that on power up/reset initializes with a default value that is not highly suitable under all device parameters for the training of link 410 to a desired link width of eight lanes (numbered lane 0 through lane 7). If link 410 does not train to a link width of at least one lane, CPU 402 cannot communicate with the controller at all.

In particular, register 420 affects the controller's physical link parameters, specifically its sensitivity to noise. Each lane in link 410 is a serial channel with a serializer/deserializer (SERDES) at each end. The sensitivity affects how the SERDES locks onto training patterns, and the use of a threshold differentiating between noise and an actual signal. Under the default value, noise may be interpreted as signal and therefore the controller may try to lock onto noise and fail to train properly.

In at least some cases, the misinterpretation may occur on only a subset of the lanes within link 410 and/or controller 406 may be screened at manufacturing time to help ensure that the misinterpretation does not occur on at least lane 0, thus improving the chances that link 410 will train to at least one lane even under the default value of register 420 (allowing CPU 402 to communicate at all with controller 406).

With respect to practical limitations as referenced above, in at least one implementation, lane 0 is unique with respect to link 410 training down to fewer lanes than the desired link width of eight lanes. If all eight lanes are successful during link training, the link width is eight lanes. If any lanes other than lane 0 are not successful, the training drops the link width to fewer lanes. Depending on the implementation, if any of lanes 4-7 are not successful, the link will attempt to train on lanes 0-3 only, and if any of lanes 1-3 are not successful, the link will attempt to train on lane 0 only. If lane 0 is not successful, the link will not train at all, and no communication at all is possible across the link.

In other words, if the link does not train at all, no communication is possible over the link to try to make the link better. (This would not necessarily be the case if the controller had a sideband mechanism, e.g., I2C, by which the CPU could configure the controller's SERDES functionality to communicate across link 410.) Thus, the CPU can establish a link width of at least one lane, the CPU can communicate with the controller and reconfigure it to communicate in an improved way, and possibly at the full desired link width (here, eight lanes), after a power cycle or re-enabling of the link.

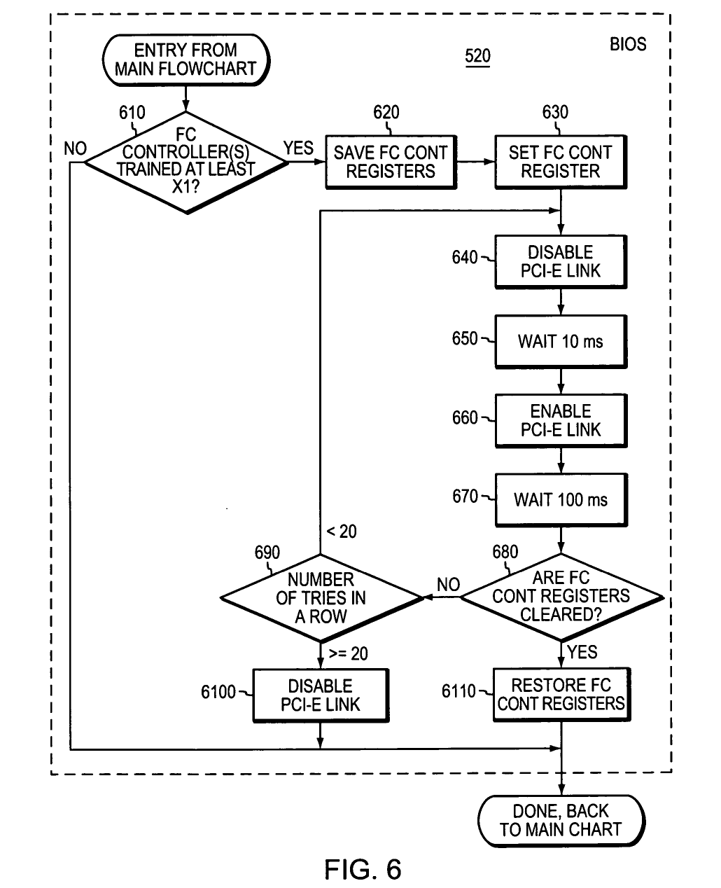

FIG. 6 illustrates BIOS-executed procedure 520 which is described in detail below. If the BIOS can communicate with controller 406, it sets register 420 to a value that is more suitable to successful training than the default value and then disables and re-enables link 410 in an attempt to establish link 410 with a full link width of eight lanes. Some wait steps are included to address practical limitations in interacting with controller 406 with respect to re-enabling link 410.

Procedure 520 also includes checks to determine whether the setting of the register takes place properly, and directs retries if not.

If, on power up/reset, link 410 did not train to at least one lane (step 610), procedure 520 is terminated and control is returned to procedure 510. Otherwise, registers of controller 406 are saved (e.g., for all PCI Express functions of the device) (step 620) and register 420 is set to the more suitable value (step 630). Link 410 is disabled (step 640), and after a delay (e.g., 10 ms) (step 650), link 410 is re-enabled (step 660). After another delay (e.g., 100 ms) (step 670), registers of controller 406 are checked to determine whether they are cleared (step 680). If not, depending on whether steps 640 through 680 have already been tried a specified number of consecutive times (e.g., twenty consecutive times) (step 690), the procedure either executes steps 640 through 680 again or disables the link (step 6100) and returns control to procedure 510. If the registers of controller 406 are cleared, registers are restored to settings saved in step 620 (step 6110) before control is returned to procedure 510. With respect to register 680, a link that fails to initialize returns a value having each bit equal to 1 for a controller register read, and therefore such a case should be treated as if the registers were not cleared.

Another practical limitation is the reason that steps 640 through 680 are tried a specified number of consecutive times. In particular, controller 406 has two clock domains, and there is only a probability (e.g., an 80% chance) that registers will clear in step 680 indicating that both domains did in fact reset when the link was disabled and re-enabled. Thus, by re-trying steps 640 through 680 the specified number of consecutive times, the chance that registers are found to be clear in step 680 after the re-tries is greatly improved (e.g., to a level of near certainty that far surpasses Six Sigma standards, if an 80% chance is tried twenty times).

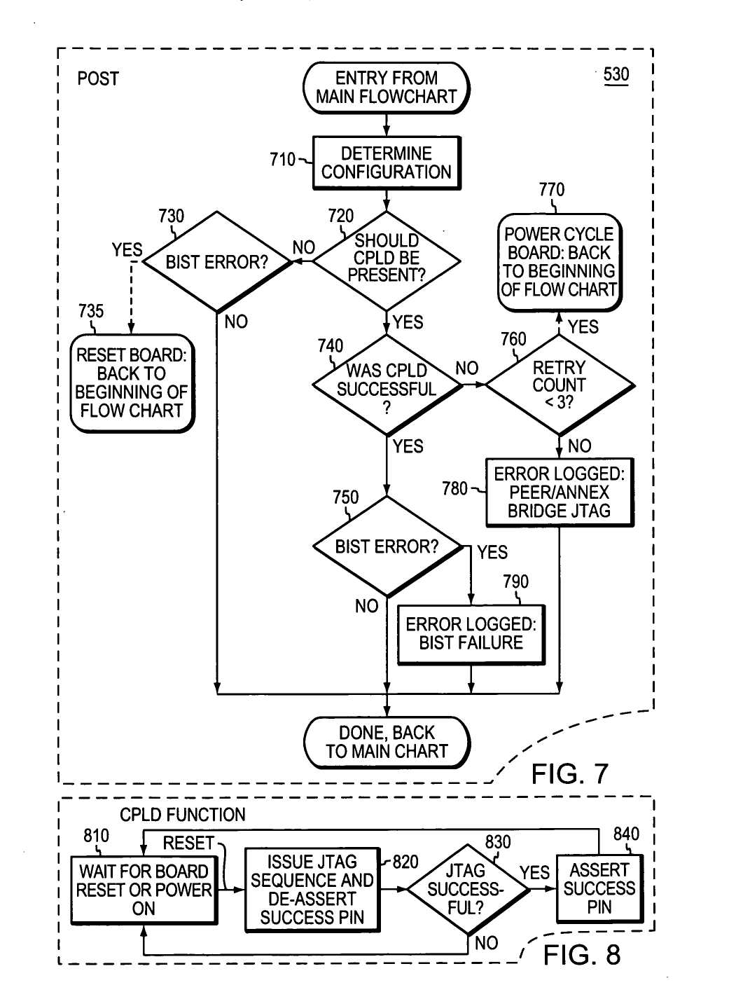

FIG. 7 illustrates POST-executed procedure 530 in detail as described below. To execute properly after power up, switch 408 needs to have a RAM cell register changed, and the only way to change it is to initiate JTAG sequences. On power up/reset, CPLD 416 changes the value of register by initiating JTAG commands. When the CPLD is done executing JTAG commands, it reports successful completion on a signal. This occurs immediately at bootup and should complete well before POST runs. In addition, resistor 418 is used as a pull down resistor and can be detected as present by reading register 422, which is from a generic input output cell of switch 408. The presence of resistor 418 is used to indicate that the CPLD is present, so that POST code can be prepared for and compatible with future versions of switch 408 that do not need the RAM cell register value changed; if the resistor is absent, the CPLD is assumed to be absent as well.

Furthermore, in at least one implementation, the CPLD may not power up and initialize properly; thus, if the CPLD does not report success, power cycling is attempted up to a specified number of times (e.g., up to three times) before an error is logged with respect to switch 408.

Configuration is determined (e.g., using an I2C architecture) (step 710) and register 422 is read to determine whether the CPLD should be present (step 720). If not, and if no BIST error was found with switch 408 (step 730), control is returned to procedure 510. If the CPLD should not be present and there is a BIST error, the board is reset (step 735). If the CPLD should be present, was successful (step 740), and no BIST error was found (step 750), control is returned to procedure 510. If the CPLD was not successful, depending on whether or not power cycling has already been tried a specified number of times (e.g., three times) (step 760), either power is cycled to allow the CPLD to try again (step 770), or control is returned to procedure 510 after an error is logged as a peer/annex bridge JTAG error (step 780). If the CPLD should be present, was successful (step 740), but a BIST error was found (step 750), control is returned to procedure 510 after an error is logged as a BIST failure error (step 790).

In a specific implementation, step 710 includes determining a PCI bus number for switch 408, and if the bus number is equal to a value (e.g., 0xFF) that indicates switch 408 is not available for communication, a power cycle is initiated.

FIG. 8 illustrates the CPLD function. After power up/reset (step 810), the JTAG sequence is issued and success is not yet reported (step 820). If the sequence is successful (830), success is reported (step 840) before the CPLD awaits power up/reset again.

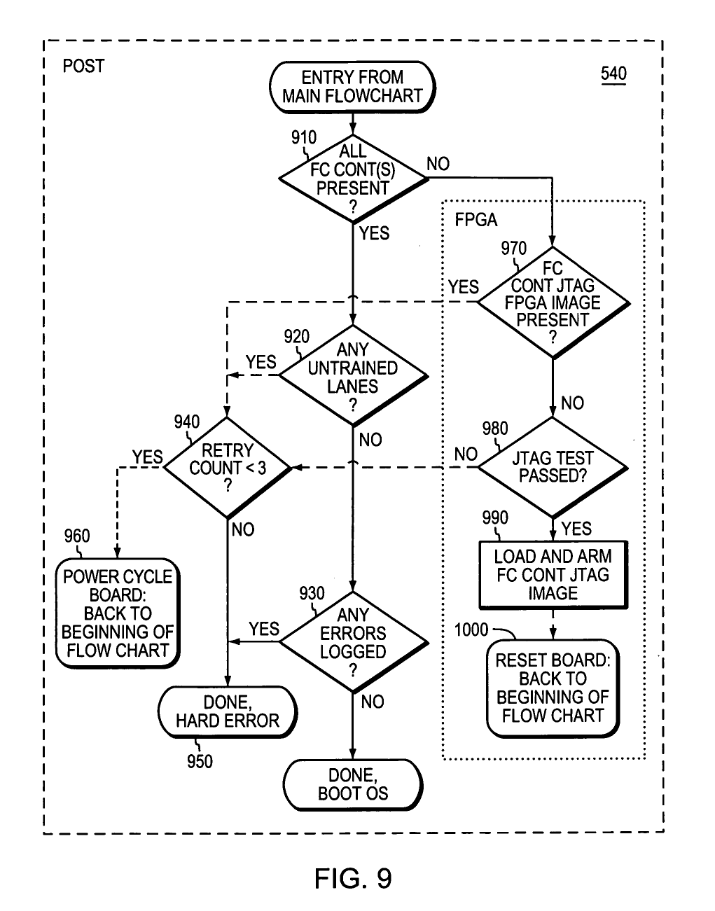

FIG. 9 illustrates POST-executed procedure 540 in detail as described below. If controller 406 cannot be accessed at all (i.e., link 410 trained to a link width of zero), procedure 540 is attempted before power cycling is attempted. In particular, FPGA 414 may be used to issue JTAG commands to controller 406. CPU 402 can communicate with the FPGA via Northbridge 404 over RS-232 link 430 to determine whether the FPGA is already programmed with an image to issue the JTAG commands. If not, CPU 402 can run a JTAG test sequence to test connections and then can program the image into the FPGA via Northbridge 404 so that the JTAG commands are issued by the FPGA after reset.

If controller 406 is present (i.e., link 410 has trained to a link width of at least one lane) (step 910), and there are no untrained lanes (i.e., link 410 has trained to a link width of eight lanes) (step 920), and no errors have been logged (step 930), control is returned to procedure 510 so that the operating system can be loaded. If controller 406 is present and there are untrained lanes (i.e., link 410 has trained to a link width of less than eight lanes), and either errors have been logged or power cycling has already been tried a specified number of times (e.g., three times) consecutively (step 940), a hard error is reported and POST is halted (step 950). Power cycling is initiated (step 960) if controller 406 is present and there are untrained lanes and power cycling has not already been tried a specified number of times consecutively.

If controller 406 is not present, and either the image is already programmed into the FPGA (step 970) or the JTAG test sequence failed (step 980), either power cycling is initiated or POST is halted with a hard error reported, depending on the number of times power cycling as already been tried.

If controller 406 is not present and the image is not already programmed and the JTAG test sequence passed (step 980), the image is programmed into the FPGA (step 990) before the board is reset (step 1000).

The present invention is not to be limited in scope by the specific embodiments described herein. Indeed, various modifications of the present invention, in addition to those described herein, will be apparent to those of ordinary skill in the art from the foregoing description and accompanying drawings. Thus, such modifications are intended to fall within the scope of the invention. Further, although aspects of the present invention have been described herein in the context of a particular implementation in a particular environment for a particular purpose, those of ordinary skill in the art will recognize that its usefulness is not limited thereto and that the present invention can be beneficially implemented in any number of environments for any number of purposes. For example, the techniques described above may be used with multiple Northbridges and/or multiple FC controllers and/or multiple PCI Express switches. Logic other than the FPGA and/or the CPLD may be used to issue the JTAG commands.

What is claimed is:

1. A method for use in managing system availability, comprising:
determining that a data communications link has been established;
determining that the data communications link is less than fully functional;
communicating across the data communications link to a device to configure the device for the data communications link; and
causing the device to re-establish the data communication link based on the results of the configuring.

2. The method of claim 1, further comprising:
power cycling the device.

3. The method of claim 1, wherein the data communications link includes a PCI Express link.

4. The method of claim 1, further comprising:
communicating to the device through a Northbridge.

5. The method of claim 1, wherein the device includes a Fibre Channel controller.

6. The method of claim 1, further comprising:
communicating with the device via a Northbridge; and
communicating with a PCI Express switch via the Northbridge.

7. The method of claim 1, further comprising:
configuring the device for a high link width on the data communications link.

8. The method of claim 1, further comprising:
communicating with the device via a Northbridge;
issuing JTAG sequences to a PCI Express switch; and
communicating with the PCI Express switch via the Northbridge.

9. The method of claim 1, further comprising:
issuing JTAG sequences to the device.

10. The method of claim 1, further comprising:
programming an FPGA to issue JTAG sequences to the device.

11. The method of claim 1, further comprising:
communicating with the device via a Northbridge;
communicating with a PCI Express switch via the Northbridge; and
determining whether the PCI Express switch is configured to be driven by JTAG sequences.

12. The method of claim 1, further comprising:
saving register contents of the device before causing the device to re-establish the data communication link.

13. The method of claim 1, further comprising:
avoiding power cycling the device an excessive number of times.

14. The method of claim 1, further comprising:
communicating with the device via a Northbridge;
communicating with a PCI Express switch via the Northbridge; and
determining whether JTAG sequences have been successfully issued to the PCI Express switch.

15. The method of claim 1, further comprising:
determining whether an FPGA has already been programmed to issue JTAG sequences to the device.

16. The method of claim 1, further comprising:
determining that the data communications link does not includes as many lanes as desired.

17. A system for use in managing system availability, comprising:
a data storage system having a storage processor communicating with disk drives;
first logic determining that a data communications link has been established on the storage processor;
second logic determining that the data communications link is less than fully functional;
third logic communicating across the data communications link to a device to configure the device for the data communications link; and
fourth causing the device to re-establish the data communication link based on the results of the configuring.

18. The system of claim 17, wherein the data communications link includes a PCI
Express link.

19. The system of claim 17, wherein the device includes a Fibre Channel controller.

20. The system of claim 17, further comprising:
a Northbridge communicating with the device;
a PCI Express switch communicating with the Northbridge;
an FPGA issuing JTAG sequences to the device; and
a CPLD issuing JTAG sequences to the PCI Express switch.
